(19) United States
(12) Patent Application Publication
(10) Pub. No.: US 2012/0281088 A1
(43) Pub. Date: Nov. 8, 2012

(54) WIRELESS MONITORING SYSTEM

(75) Inventor: XIAO-YU FAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/211,327

(22) Filed: Aug. 17, 2011

(30) Foreign Application Priority Data
May 5, 2011 (CN) 201120140073.2

(51) Int. Cl. H04N 7/18

(52) U.S. Cl. 348/143; 348/159; 348/E07.085

(57) ABSTRACT

An image capturing apparatus includes a number of cameras, an image processor a wireless transmitter and a transmitting antenna. The cameras are mounted in a modular data center and capture images of the modular data center. The image processor incorporates the captured images to from a monitoring image. The wireless transmitter sends the monitoring image to a remote monitoring apparatus via the transmitting antenna.

### BACKGROUND

1. Technical Field

The disclosure generally relates to wireless monitoring systems, and particularly to a wireless monitoring system for modular data centers.

2. Description of Related Art

Modular data centers are typically an intermodal shipping container that can be delivered to a particular site. The shipping container contains all necessary computer components such as servers, storages and network apparatus for computation. Modular data centers are widely used for their movability and high data processing ability. However, when the modular data centers are in delivery or at a remote site, it is inconvenient for users to monitor.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a block diagram of a wireless monitoring system, according to an exemplary embodiment of the disclosure.

FIG. 2 is a flowchart of an exemplary method of using the wireless monitoring system shown in FIG. 1 to monitor a modular data center.

### DETAILED DESCRIPTION

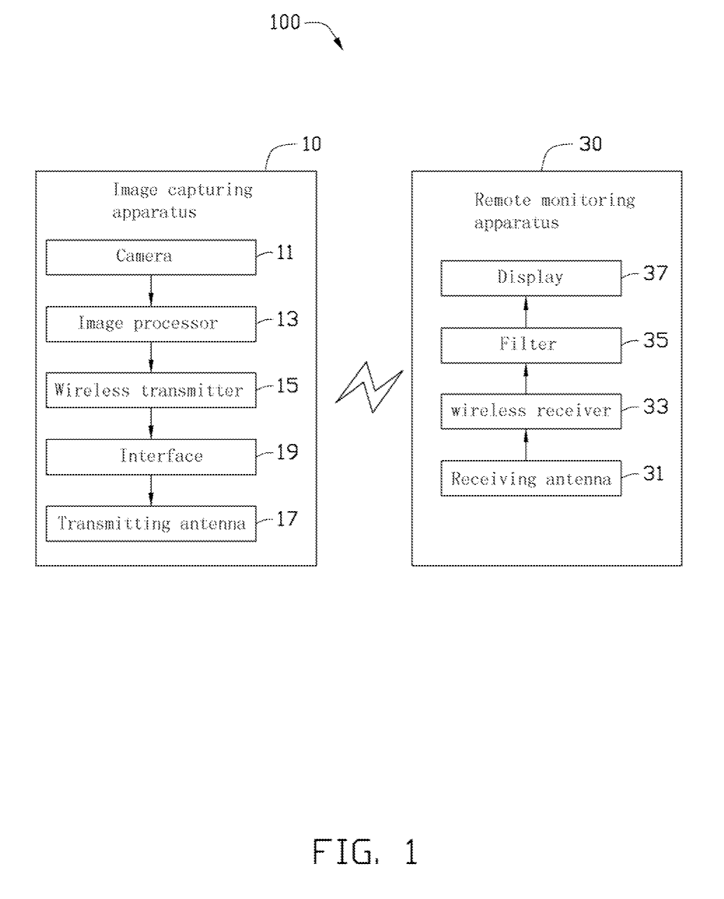

FIG. 1 is a block diagram of a wireless monitoring system 100, according to an exemplary embodiment of the disclosure. The wireless monitoring system 100 includes an image capturing apparatus 10 and a remote monitoring apparatus 30.

The image capturing apparatus 10 includes a plurality of cameras 11, an image processor 13, a wireless transmitter 15, and a transmitting antenna 17 connected in series. The cameras 11 can be mounted inside or external to the modular data center to form a monitoring region and capture images within the monitoring region (such as the modular data center, computers inside the modular data center, or an environment that is internal or external to the modular data center).

The image processor 13 receives the images captured by the cameras 11, and shrinks the images to be 1/N of their original sizes, where N denotes the number of the cameras or the number of the images. Then, the image processor 13 incorporates the shrunk images together and forms a monitoring image. The monitoring image is a dynamic image which includes a plurality of sub-images joined together used to monitor the modular data center for users. Each shrunk image is served as a sub-image of the monitor image.

The wireless transmitter 15 obtains the monitoring image from the image processor 13 and transmits the monitoring image to the remote monitoring apparatus 30 via the transmitting antenna 17.

The transmitting antenna 17 is detachably mounted outside the modular data center by an interface 19. The interface 19 may be a hardware circuitry or associated circuitry or mechanical components of a connector/port that connect the transmitting antenna 17 to the modular data center. When the wireless monitoring system 100 is not used, the transmitting antenna 17 can be disassembled from the interface 19. Thus, the modular data center can be conveniently delivery.

The remote monitoring apparatus 30 includes a receiving antenna 31, a wireless receiver 33, a filter 35, and a display 37.

The wireless receiver 33 corresponds to the wireless transmitter 33. The wireless receiver 33 and the wireless transmitter 15 communicate with each other via a wireless transmission protocol. The wireless receiver 33 receives the monitoring image from the wireless transmitter 15 via the receiving antenna 31 and transmits the monitoring image to the filter 35. The filter 35 reduces noise in the monitoring image. The display 37 displays the monitoring image.

In other embodiments, a plurality of the wireless monitor systems 100 can be used to monitor multiple modular data centers. Each wireless transmitter 15 and corresponding wireless receiver 33 can communicate with each other at a certain frequency band. Interference may generated between the wireless monitor systems 100 can be effectively prevented.

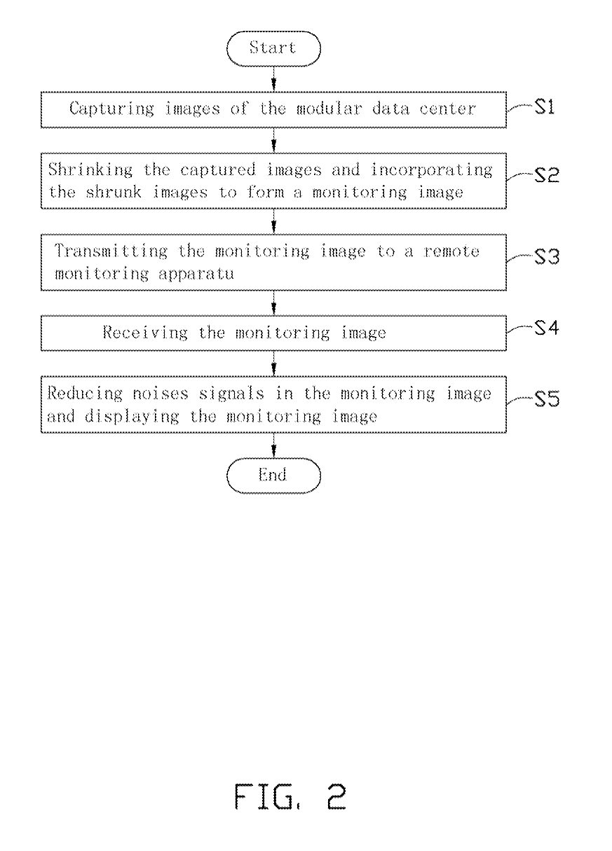

Referring to FIG. 2, a process of using the wireless monitoring system to monitor a modular data center may include following steps.

In step S1, the cameras 11 captures images of the modular data center, and sends the captured images to the image processor 13.

In step S2, the image processor 13 shrinks the captured images to be 1/N of their original sizes, and incorporates the shrunk images together to form a monitoring image.

In step S3, the wireless transmitter 15 obtains the monitoring image from the image processor 13 and transmits the monitoring image to the remote monitoring apparatus 30 via the transmitting antenna 17.

In step S4, the wireless receiver 33 receives the monitoring image from the wireless transmitter 15 via the receiving antenna 31 and transmits the monitoring image to the filter 35.

In step S5, the filter 35 reduces noises signals in the monitoring image and the display 37 displays the monitoring image for users.

The wireless monitor system 100 captures images of the modular data center by the cameras 11 mounted in the modular data center, and transmits the captured images to the remote monitoring apparatus 30 via wireless communication. Users can remotely monitor the modular data center without limitation of location.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An image capturing apparatus in electronic communication with a remote monitoring apparatus, wherein the image capturing apparatus is mounted inside or external to a modular data center, the image capturing apparatus comprising:
a plurality of cameras that are operable capture images of a surrounding environment;
an image processor that shrinks the captured images to be 1/N of an original size of the images, where N denotes the number of the cameras, and incorporates the shrunk images together to form a monitoring image, the monitoring image comprising a plurality of sub-images joined together, and each shrunk image serving as a sub-image of the monitor image;
a transmitting antenna; and
a wireless transmitter that sends the monitoring image to the remote monitoring apparatus by the transmitting antenna.

2. The image capturing apparatus of claim 1, further comprising an interface, wherein the wireless transmitter is detachably mounted to the modular data center by the interface.

3. The image capturing apparatus of claim 1, wherein the wireless transmitter transmits the monitoring image at a determined frequency band.

4. A remote monitoring apparatus in electronic communication with an image capturing apparatus, the remote monitoring apparatus comprising:
a receiving antenna;
a wireless receiver receiving a monitoring image of a modular data center from the image capturing apparatus by the receiving antenna; and
a display displaying the monitoring image.

5. The remote monitoring apparatus of claim 4, further comprising a filter, the filter reduces noises of the monitoring image, and then the display displays the monitoring image.

6. The remote monitoring apparatus of claim 4, wherein the wireless receiver receives the monitoring image at a determined frequency band.

7. A modular data center monitoring method, comprising:
capturing images of the modular data center;
shrinking the captured images to be 1/N of an original size of the images, where N denotes the number of the cameras;
incorporating the shrunk images together to form a monitoring image; and
sending the monitoring image to a remote monitoring apparatus; wherein the monitoring image is a dynamic image which includes a plurality of sub-images jointed together, and each shrunk image is served as a sub-image of the monitor image.

8. The modular data center monitoring method of claim 7, further comprising reducing noises signals in the monitoring image and displaying the monitoring image.
